(19) United States
(12) Patent Application Publication
(10) Pub. No.: US 2026/0067255 A1
(43) Pub. Date: Mar. 5, 2026

(54) SD-WAN CATALYST MANAGER-DRIVEN AUTOMATED PROVISIONING OF SSE

(71) Applicant: Cisco Technology, Inc., San Jose, CA (US)

(72) Inventors: Shailendra Vinod Pardeshi, Dublin, CA (US); Mahalakshmi Rajaram, Fremont, CA (US); Ambika Basappa Chandrappa, Milpitas, CA (US); Yogesh Mittal, Sunnyvale, CA (US); Nithin Bangalore Raju, Santa Clara, CA (US); Venkatesh Nataraj, Union City, CA (US); Ashwin Kumar Ravichandran, Santa Clara, CA (US)

(21) Appl. No.: 19/009,635

(22) Filed: Jan. 3, 2025

Related U.S. Application Data
(60) Provisional application No. 63/688,058, filed on Aug. 28, 2024.

(51) Int. Cl. H04L 9/40

(52) U.S. Cl. CPC H04L 63/029; H04L 63/20

(57) ABSTRACT

In some aspects, a method may include receiving, from a user device associated with a communication network, a policy that includes an intent to configure a security service edge (SSE) provider. The method may further include transmitting the policy to a router associated with the communication network and receiving a request for a secure tunnel between the router and the SSE provider. Using one or more application programming interfaces (APIs), the method may further include determining information associated with at least one datacenter via which services by the SSE provider are accessible. The method may further include generating tunnel configurations for the secure tunnel associated with the router. The method may further include generating an action command that includes instructions for configuring the secure tunnel between the router and the SSE provider using the tunnel configurations and transmits the action command to the router.

### CROSS-REFERENCE TO RELATED APPLICATIONS

This application claims priority to U.S. Patent Application No. 63/688,058, filed Aug. 28, 2024, entitled “SDWAN CATALYST MANAGER DRIVEN AUTOMATED PROVISIONING OF SSE,” which is incorporated by reference herein in its entirety.

### TECHNICAL FIELD

The present technology pertains to network security, and, more specifically, to controller-driven provisioning of SSE providers.

### BACKGROUND

In a multi-tenanted network, establishing secure communication channels between devices and Security Service Edge (SSE) providers is critical to protecting data privacy and integrity across tenants. Secured tunnels, such as IPsec, GRE, or SSL/TLS, provide encrypted connections that isolate each tenant's data traffic, preventing unauthorized access while in transit. These secure tunnels ensure that sensitive information exchanged between devices and SSE providers, such as authentication credentials, configurations, and user data, remains protected from interception and tampering. In this multi-tenant environment, tunneling protocols play a key role in both compliance and security by maintaining clear boundaries between tenant data streams and enabling scalable, secure connectivity across diverse, distributed networks.

### BRIEF DESCRIPTION OF THE DRAWINGS

To easily identify the discussion of any particular element or act, the most significant digit or digits in a reference number refer to the figure number in which that element is first introduced.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example of a high-level network architecture according to some aspects of the present disclosure.

FIG. 2 illustrates a block diagram of a controller-driven architecture for a multi-tenanted SDWAN network according to some aspects of the present disclosure.

FIG. 3 illustrates a diagram of transmissions between devices of a controller-driven architecture for a multi-tenanted network according to some aspects of the present disclosure.

FIG. 4 illustrates a method for executing a controller-driven architecture on a multi-tenanted network according to some aspects of the present disclosure.

FIG. 5 shows an example of a system for implementing certain aspects of the present technology according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

### Overview

On an SDWAN network, firewalls and other security measures may be implemented using one or more Security Service Edge (SSE) providers hosted at a cloud provider and reachable on the Internet. Communications between devices and the one or more SSE providers may be transmitted with one or more secured tunnels. To configure the tunnels, the devices may require information including a destination Internet Protocol (IP) address, pre-shared security key, etc. By utilizing a controller to obtain the information required to configure the tunnels, the amount of Application Programming Interface (API) calls associated with the one or more SSE providers may be reduced, which may reduce the processing power and resources required to set up the one or more secured tunnels. The controller may obtain the information required to configure the tunnels and distribute the information to the devices associated with the SDWAN network accordingly, along with an action command instructing the devices to set up respective secured tunnels with the one or more SSE providers.

In one aspect, a method may include receiving, from a user device associated with a communication network, a policy. The policy may include an intent to configure a security service edge (SSE) provider. The method may further include transmitting the policy to a router associated with the communication network and receiving, from the router, a request for a secure tunnel between the router and the SSE provider. Using one or more application programming interfaces (APIs), the method may further include determining information associated with at least one datacenter via which services by the SSE provider are accessible. The method may further include generating tunnel configurations for the secure tunnel associated with the router. Based on the information associated with the at least one datacenter, the method may further include generating an action command that includes instructions for configuring the secure tunnel between the router and the SSE provider using the tunnel configurations and transmit the action command to the router.

In some other aspects, the method may further include storing the information associated with the at least one datacenter in a database associated with the communication network and querying the database for the information associated with the at least one datacenter in response to a subsequent request for an additional secure tunnel associated with the SSE provider.

In some other aspects, the tunnel configurations include at least one of a tunnel destination Internet Protocol (IP) address and a secure key.

In some other aspects, the one or more APIs are used to request location information of at least one datacenter associated with the SSE provider, the location information being included in the information associated with the at least one datacenter.

In some other aspects, the method may further include receiving, from the user device associated with the communication network, a second policy, wherein the second policy includes an intent to configure a second SSE provider to which the router can establish a respective secure tunnel.

In some other aspects, the information associated with the at least one datacenter includes at least a destination IP address and a geolocation associated with one or more datacenters of the SSE provider.

In some other aspects, wherein when the router receives the action command, the router establishes the secure tunnel with the SSE provider using the action command.

In one aspect, a system may include one or more processors and a memory storing instructions that, when executed by the one or more processors, cause the system to receive, from a user device associated with a communication network, a policy. The policy may include an intent to configure a security service edge (SSE) provider. The system may further transmit the policy to a router associated with the communication network and receiving, from the router, a request for a secure tunnel between the router and the SSE provider. Using one or more application programming interfaces (APIs), the system may further determine information associated with at least one datacenter via which services by the SSE provider are accessible. The system may further generate tunnel configurations for the secure tunnel associated with the router. Based on the information associated with the at least one datacenter, the system may further generate an action command that includes instructions for configuring the secure tunnel between the router and the SSE provider using the tunnel configurations and transmit the action command to the router.

In one aspect, a non-transitory computer-readable storage medium may include instructions, that when executed by a computer, cause the computer to receive, from a user device associated with a communication network, a policy. The policy may include an intent to configure a security service edge (SSE) provider. The computer may further transmit the policy to a router associated with the communication network and receiving, from the router, a request for a secure tunnel between the router and the SSE provider. Using one or more application programming interfaces (APIs), the computer may further determine information associated with at least one datacenter via which services by the SSE provider are accessible. The computer may further generate tunnel configurations for the secure tunnel associated with the router. Based on the information associated with the at least one datacenter, the computer may further generate an action command that includes instructions for configuring the secure tunnel between the router and the SSE provider using the tunnel configurations and transmit the action command to the router.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

This disclosure presents a solution for implementing security from Security Service Edge (SSE) providers on an SDWAN network. In an SDWAN network, firewalls (and other security measures) may be operated offsite as a service reachable on the Internet (i.e., SSE providers, such as Zscalar, Cisco Umbrella, etc.). In this instance, traffic from devices on the SDWAN network are to be transmitted via secured tunnels to the SSE providers. Traditionally, administrators of the SDWAN network may provide details of the SSE providers (e.g., web URL, account credentials, etc.) to a controller of the SDWAN network, and the controller forwards the details to one or more devices (e.g., routers) on the SDWAN network to instantiate secure communications tunnels (e.g., Generic Routing Encapsulation (GRE), Internet Protocol Security (IPSEC), etc.) with the SSE providers. This approach often requires the one or more devices to be cognizant of the full control plane (e.g., the API handshake between a device and an SSE provider) before the data plane (e.g., the secured tunnels) can be set up. Any changes in the API model would require changes on the one or more devices. Additionally, supporting a new SSE provider would require developing a full stack on the one or more devices. This would drastically slow down feature rollouts by requiring upgrades to the one or more devices. In other scenarios, such as an SDWAN network that does not include a central controller, the client provisions one or more tunnel endpoints on an SSE portal and manually copy out a pre-shared key and configure the one or more devices with the pre-shared key to set up the secured tunnels. Once the one or more devices receive the pre-shared key, the one or more devices are required to orchestrate the specific API calls required for specific SSE providers. The one or more devices may attempt to perform the specific API calls within a similar time frame (e.g., on setup/initialization of a new SSE provider), which may cause the API rate limit associated with the SSE provider to hit, thereby slowing and causing unnecessary latency in the SDWAN network.

To address the shortcomings described above, the present disclosure provides for a controller-driven architecture developed for connectivity to one or more SSE providers. Across multiple SSE providers and/or devices associated with the SDWAN network, the device-side configuration (e.g., routers), including the tunnel attribute configuration, may be a standard (e.g., IPSEC, GRE, etc.) configuration and common for most SSE providers. However, in some examples, the API interactions associated with different SSE providers may be specific to the SSE provider (e.g., Zscalar may require different API interactions to conduct an API handshake compared to Cisco Umbrella). The controller associated with the SDWAN network may orchestrate the set of calls to the SSE providers and may transmit the generated tunnel configurations to the devices for instantiation of secure SSE tunnels. Without this controller-driven architecture, each device would be required to orchestrate the specific API calls for the individual SSE providers. Further, using the controller-driven approach, isolation may be achieved between the control plane and the data plane. Additionally, it may be possible to support new SSE providers with changes made only on the controller, not all devices on the SDWAN network.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

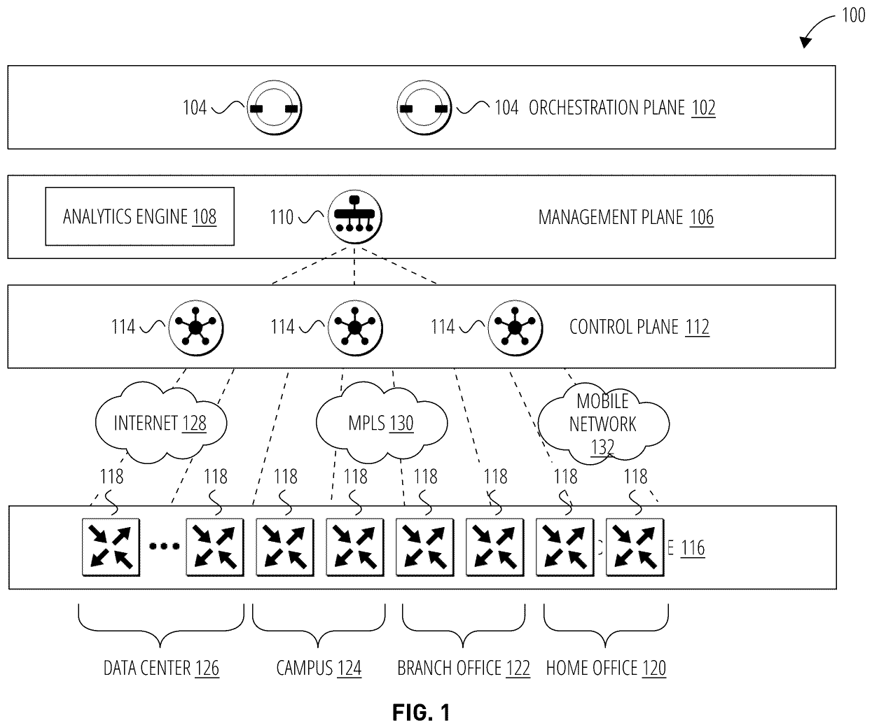

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include one or more physical or virtual network management appliances 110 and an analytics engine 108. The analytics engine 108 may monitor network performance, analyze traffic patterns, and provide insights to optimize routing, security, and application performance across the network. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances 114. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as via one or more internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 118.

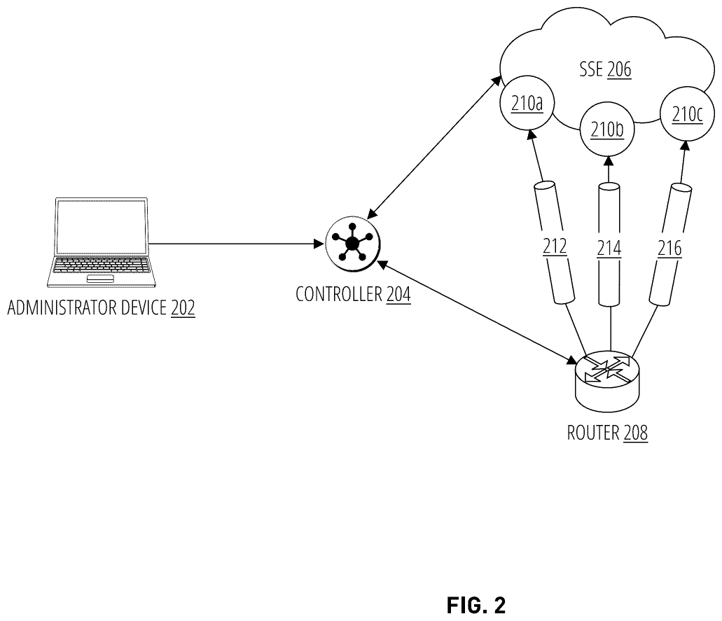

FIG. 2 illustrates an example block diagram of an SDWAN network with a controller-driven architecture according to some aspects of the present disclosure. The SDWAN network may be comprised of an administrator device 202, controller 204, SSE 206, and one or more devices, which may include at least router 208 (While FIG. 2 illustrates a single router 208, the number of routers is not limited to one but may include any number of routers).

SSE 206 may include one or more SSE providers, which may include SSE provider 210a, 210b, and/or 210c (collectively, SSE providers 210). SSE providers 210 may be cloud-based security providers (e.g., associated with a cloud network SSE 206) that delivers comprehensive network security service to the SDWAN network, which may include secure access, data protection, threat prevention, and/or compliance enforcement. By integrating services (e.g., secure web gateways (SWG), cloud access security brokers (CASB), zero-trust network access (ZTNA), and the like), SSE providers 210 may ensure secure and seamless access to cloud-based and on-premises applications from one or more locations associated with the SDWAN network.

To access SSE providers 210, the one or more devices associated with the SDWAN network may utilize one or more secured tunnels. For example, SSE providers 210 of SSE 206 may be associated with a secured tunnel for a respective device (e.g., router 208). Transmissions between SSE provider 210a and router 208 may be via tunnel 212, SSE provider 210b and router 208 may communicate via tunnel 214, and SSE provider 210c and router 208 may communicate via tunnel 216. Tunnels 212, 214, and 216 may be instantiated using one or more tunnel protocols, including, but not limited to, IPSEC, GRE, Secure Sockets Layer/Transport Layer Security (SSL/TLS), Secure Shell (SSH), Multiprotocol Label Switching (MPLS), Layer 2 Tunneling (L2TP), Dynamic Multipoint (DMVPN), any combination thereof, or the like. The tunnels may be set up using one or more application programming interface (API) communications.

In some examples, SSE providers 210 may require individual API communications that are distinct from one another. For example, SSE provider 210a may require a different set of API calls and/or data to set up a tunnel than SSE provider 210b. Instead of router 208 facilitating the API calls (e.g., transmitting communications between SSE providers 210 to obtain necessary information to set up the tunnels), controller 204 may exchange data (via one or more APIs) with SSE providers 210 to obtain the necessary information for tunnel setup.

To initiate this process, controller 204 may receive a configuration, policy, credentials, any combination thereof, or the like, via a transmission from administrator device 202 (e.g., via a user interface/portal accessible on administrator device 202). Administrator device 202 may be a device associated with the SDWAN network and configured to manage the SDWAN network. The transmission may include an intent to configure one or more providers of SSE providers 210 with the SDWAN network. For example, the intent may include a request to build a specific type of secure tunnel, a location of the secure tunnels (e.g., between a first portion of the network and an SSE provider), number of secure tunnels, datacenter preferences (e.g., using a datacenter associated with the SSE provider that is in closest geographic proximity to the network, choosing a primary and/or secondary datacenter, etc.). In some examples, all or some of the intent may be configured as dynamic keywords when forwarded to router 208. In some examples, the whole or part of the transmission is forwarded to router 208. For example, router 208 may receive the intent to configure SSE providers 210 with the SDWAN network. Router 208 may evaluate the intent to configure and may determine that router 208 does not have access to data necessary to configure SSE providers 210. For example, router 208 may not have the data necessary to set up secure tunnels associated with SSE provider 210a.

Router 208 may forward this determination (e.g., that router 208 does not have access to data necessary to configure SSE providers 210) to controller 204. The forwarded determination may include a request for the necessary data for setting up the secure tunnels, establishing a connection, etc. Controller 204 may orchestrate a set of API calls for a respective SSE provider requesting the necessary data. The set of API calls may be generated per SSE provider. For example, the API calls associated with SSE provider 210a may differ from the API calls associated with SSE provider 210b. For example, the API calls may include requests for authentication, VPN credentials, location, sub-locations, activation, a nearest datacenter, a static identifier (ID), tunnel ID, any combination thereof, or the like. The responses to the one or more API calls may be stored in a database accessible to controller 204 and/or router 208 (and other devices associated with the SDWAN network). The responses may include necessary data to generate one or more secured tunnels associated with SSE providers 210, such as a router IP, a remote IP (e.g., SSE provider IP), a pre-shared key, any combination thereof, or the like. The responses may be used to generate one or more tunnel configurations associated with router 208. For example, the responses may include instructions and/or necessary data (e.g., Tunnel Destination IP, Pre-shared Key, etc.) to set up tunnel 212 associated with SSE provider 210a and router 208. Controller 204 may transmit necessary data to router 208. Router 208 may set up the one or more secured tunnels (e.g., using an Internet Key Exchange (IKE) negotiation) using the necessary data obtained using the one or more API calls. In some examples, controller 204 may transmit an action command to router 208 and/or additional devices on the SDWAN network. The action commands may be customized to the respective device (e.g., include destination IP addresses of datacenters in closest proximity to the respective device). The action command may include the necessary data to set up the one or more secured tunnels in response to the initial request from router 208 for tunnel parameters.

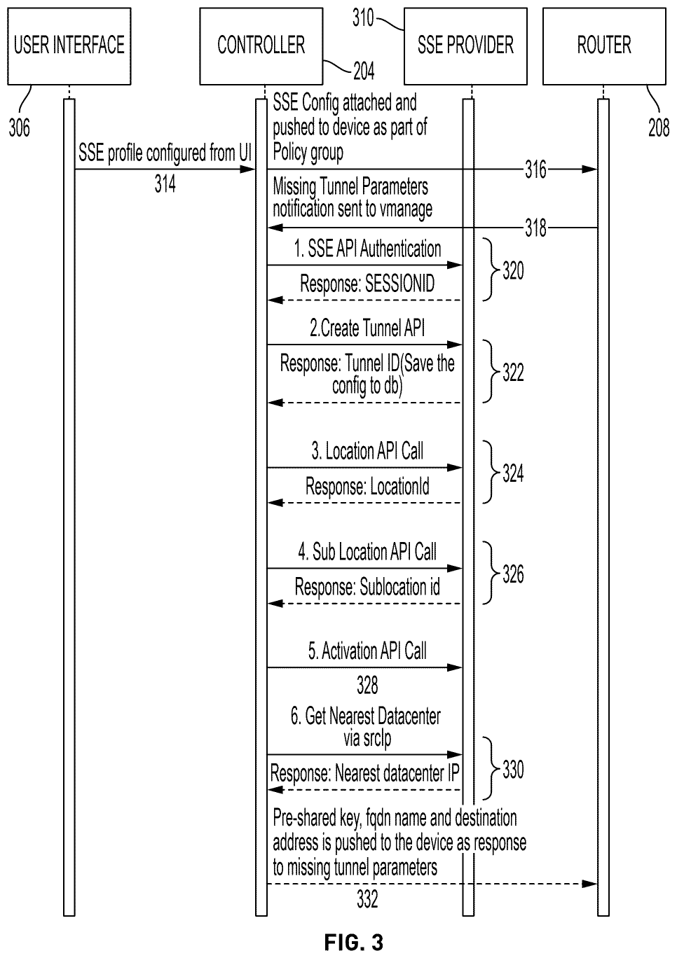

FIG. 3 illustrates an example process for setting up one or more secured tunnels at a network device according to some aspects of the present disclosure. User interface 306 (e.g., of administrator device 202 as described in FIG. 2), controller 204, SSE provider 310 (e.g., SSE provider 210a as described in FIG. 3), and router 208 may transmit one or more communications between devices. In some examples, the one or more communications may be transmitted through one or more custom APIs configured to transmit data between devices.

Transmission 314 may include a command from user interface 306 to configure one or more SSE providers associated with a cloud network, such as SSE provider 310. The command may include security policies, configurations, network setup information, any combination thereof, or the like. The command may include instructions to set up a secured tunnel between router 208 and SSE provider 310. Controller 204 may forward the command (e.g., as transmission 316) to one or more devices associated with a multi-tenanted network, including, but not limited to, router 208. Router 208 may process the command and identify missing tunnel parameters. The missing tunnel parameters may be data necessary to set up a secured tunnel between router 208 and SSE provider 310. The missing tunnel parameters may be identifiers (e.g., IP addresses, MAC addresses, port identifiers, etc.), security protocol elements (e.g., a pre-shared key), source and/or destination references (e.g., destination IP addresses, source IP addresses, etc.), any combination thereof, or the like. Router 208 may transmit a request for the missing tunnel parameters to controller 204 via communication 318.

Based on the missing tunnel parameters and characteristics of SSE provider 310, controller 204 may generate one or more API calls to SSE provider 310 to obtain data associated with the missing tunnel parameters. Communications group 320 may include a transmission from controller 204 requesting authorization and/or authentication from SSE provider 310. The authorization and/or authentication may be provided via the cloud provider associated with the cloud network of SSE provider 310. SSE provider 310 may response with a session identifier (“SESSIONID”). Communications group 322 may include a request to create a secure tunnel associated with SSE provider 310. SSE provider 310 may respond to the request with a tunnel identifier associated with a secure tunnel from SSE provider 310 to devices associated with the multi-tenanted network. The tunnel identifier may be an IP address, a port identifier, a MAC address, any combination thereof, or the like.

Controller 204 may transmit a request for a location associated with SSE provider 310 in communications group 324. The location may be associated with a geo-location of a central processing center (e.g., datacenter, controller, headquarters, primary location, etc.) of SSE provider 310. SSE provider 310 may reply to the request for the location with a location identifier, which may be an IP address, MAC address, global positioning system (GPS) coordinates, longitude and/or latitude, physical address, any combination thereof, or the like. In some examples, controller 204 may also request for one or more sub-location identifiers that may be associated with the location via communications group 326. Controller 204 may transmit an activation request via communication 328.

Controller 204 may also request for a nearest datacenter associated with SSE provider 310 in communications group 326. In some examples, controller 204 may transmit at least one geolocation of at least one device of the multi-tenanted network with the request for the nearest datacenter. The nearest datacenter may be remote datacenters, host locations, server locations, satellite centers, any combination thereof, or the like, associated with the SSE provider 310. In some examples, SSE provider 310 may reply to the request for the nearest datacenter with one or more datacenter identifiers. SSE provider 310 may generate a list of datacenters that are closest in proximity to the multi-tenanted network based on the at least one geolocation of the at least one device of the multi-tenanted network. Controller 204 may determine the closest proximity datacenter associated with the SSE provider 310. In some examples, there may be more than one closest proximity datacenter depending on the expanse of the multi-tenanted network. In that example, controller 204 may allocate a first nearest datacenter to a first group of devices associated with the multi-tenanted network and may allocate a second nearest datacenter to a second group of devices associated with the multi-tenanted network. In some examples, controller 204 may determine a nearest datacenter associated with the one or more devices of the multi-tenanted network individually (e.g., at communication 330).

Controller 204 may generate an action command and transmit the action command to router 208 via communication 332. The action command may include data received from SSE provider 310 that is necessary to set up the secured tunnel between SSE provider 310 and router 208. This may include, but is not limited to, a pre-shared key, a destination address associated with a closest proximity datacenter to router 208 (e.g., IP address, MAC address, port, etc.), domain name, any combination thereof, or the like. Router 208 may receive the action command and set up the secured tunnel using the data included in the action command.

In some examples, the data received via the one or more API calls between controller 204 and SSE provider 310 may be stored in a database accessible to controller 204, router 208, and one or more other devices on the multi-tenanted network. If a second device (e.g., a device associated with the multi-tenanted network that is not router 208) needs to set up a secured tunnel with SSE provider 310, the second device may access the database and obtain the necessary information for setting up the secured tunnel. The data in the database may be refreshed and/or purged periodically according to settings associated with the multi-tenanted network. In some examples, after the database is purged, the second device may query the database for data associated with setting up the secured tunnel. Upon finding that the database no longer includes the relevant data, the second device may transmit a request to controller 204 to orchestrate the one or more API calls to obtain the data necessary for setting up the secured tunnel.

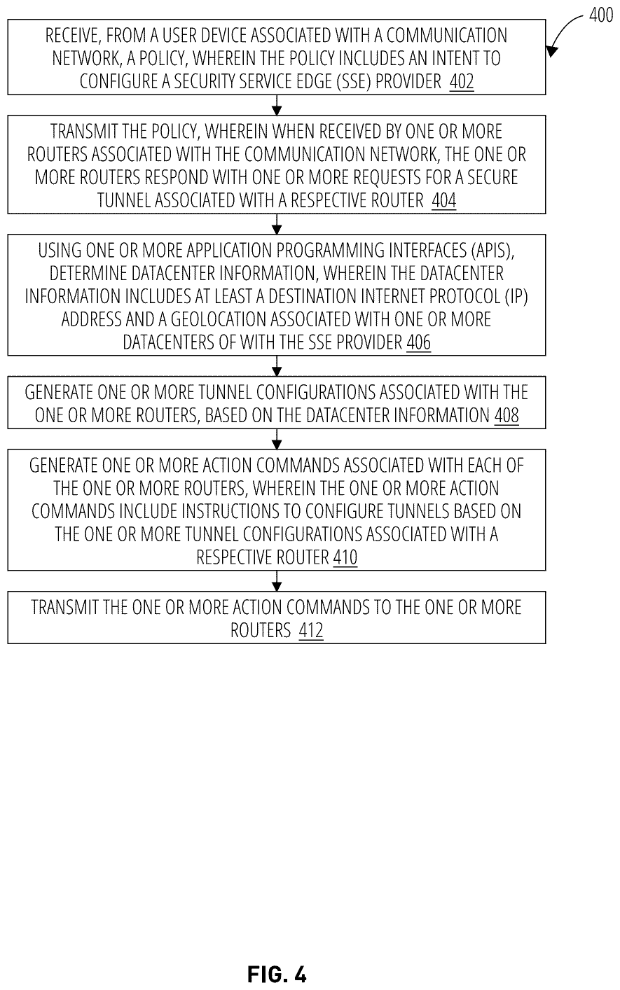

FIG. 4 illustrates a method for executing a controller-driven architecture on a multi-tenanted network according to some aspects of the present disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

In block 402 of method 400, a controller receives, from a user device associated with a communication network, a policy, wherein the policy includes an intent to configure a security service edge (SSE) provider. For example, controller 204 (as described in FIG. 2) may receive, from administrator device 202 (as described in FIG. 2), the policy, wherein the policy includes an intent to configure SSE provider 210a (as described in FIG. 2). The policy may include one or more configurations associated with secured tunnels between devices of the communication network (e.g., router 208 as described in FIG. 2 and FIG. 3). The policy may be determined by an administrator, manager, security personnel, maintenance personnel, etc., of the communication network.

In block 404 of method 400, the controller transmits the policy to one or more routers associated with the communication network. For example, controller 204 may transmit the policy to router 208 (as described in FIG. 2).

In block 406 of method 400, the controller receives, from the router, a request for a secure tunnel between the router and the SSE provider. For example, controller 204 may receive, from router 208, the request for the secure tunnel between router 208 and SSE provider 210a. The router may receive the policy, including the intent to configure a secured tunnel associated with the SSE provider, and may determine what data is necessary to configure the secure tunnel. The router may analyze the received policy and identify if there is any data that is missing from the policy that is necessary to configure the secure tunnel, and may transmit a request to the controller for the missing data.

In block 408 of method 400, using one or more application programming interfaces (APIs), the controller determines information associated with at least one datacenter via which services by the SSE provider are accessible. For example, controller 204, using one or more APIs, may determine information associated with at least one datacenter via which services by SSE provider 210a are accessible. The controller may generate the one or more APIs based on the missing data request from the router, the SSE provider, the type of tunnels requested within the policy (e.g., IPSEC, GRE, etc.), pre-existing data stored in a database associated with the controller (e.g., data received from the SSE provider previously), any combination thereof, or the like. The APIs may include a request for a location of at least one datacenter associated with the SSE provider. The SSE provider, in response to the APIs, may transmit at least a destination IP address, a secure key, and a geolocation associated with the at least one datacenter.

In some examples, the controller may store the datacenter information in a database associated with the communication network. The database may be accessible by the controller and/or the one or more routers associated with the communication network. The database may be periodically purged according to a purge policy associated with the administrator device, which may be included in the policy transmitted to the controller.

In block 410 of method 400, the controller generates tunnel configurations for the secure tunnel associated with the router, based on the information associated with the at least one datacenter. For example, controller 204 may generate tunnel configurations associated with router 208, based on the information associated with the at least one datacenter. The tunnel configurations may include a respective tunnel destination IP and a respective secure key. The respective secure key may be used to establish the secure tunnel between the SSE provider and a router.

In block 412 of method 400, the controller generates an action command that includes instructions for configuring the secure tunnel between the router and the SSE provider using the tunnel configurations. For example, controller 204 may generate the action command associated with router 208, wherein the one or more action commands include instructions to configure tunnel 212 between router 208 and SSE provider 210a. The instructions may include a destination IP address, a secure key, a geolocation associated with a datacenter of the destination IP address, and/or other instructions provided by the policy.

In block 412 of method 400, the controller transmits the action command to the router. For example, controller 204 may transmit the action command to router 208. The router may establish respective tunnels according to the one or more action commands.

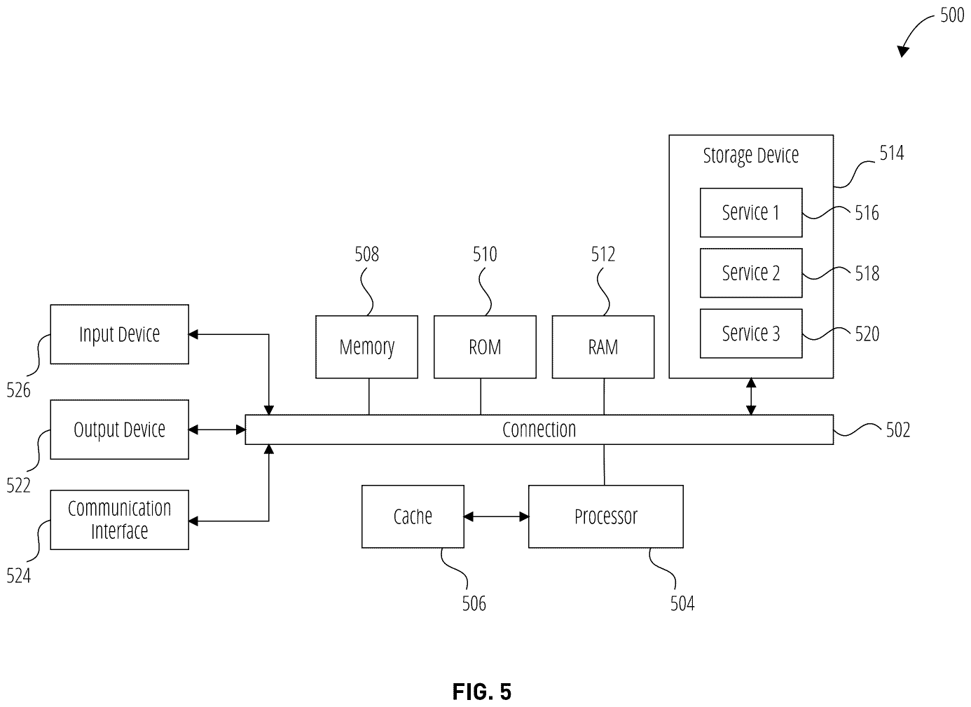

FIG. 5 shows an example of computing system 500, which can be for example any computing device making up the controller-driven architecture of FIG. 2, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random-access memory (RAM) 512 to processor 504. Computing system 500 can include a cache of high-speed memory 506 connected directly with, in close proximity to, or integrated as part of processor 504.

Processor 504 can include any general-purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method, comprising:
receiving, from a user device associated with a communication network, a policy, wherein the policy includes an intent to configure a security service edge (SSE) provider;
transmitting the policy to a router associated with the communication network;
receiving, from the router, a request for a secure tunnel between the router and the SSE provider;
using one or more application programming interfaces (APIs), determining information associated with at least one datacenter via which services by the SSE provider are accessible;
generating tunnel configurations for the secure tunnel associated with the router, based on the information associated with the at least one datacenter;
generating an action command that includes instructions for configuring the secure tunnel between the router and the SSE provider using the tunnel configurations; and
transmitting the action command to the router.

2. The computer-implemented method of claim 1, further comprising:
storing the information associated with the at least one datacenter in a database associated with the communication network; and
querying the database for the information associated with the at least one datacenter in response to a subsequent request for an additional secure tunnel associated with the SSE provider.

3. The computer-implemented method of claim 1, wherein the tunnel configurations include at least one of a tunnel destination Internet Protocol (IP) address and a secure key.

4. The computer-implemented method of claim 1, wherein the one or more APIs are used to request location information of the at least one datacenter associated with the SSE provider, the location information being included in the information associated with the at least one datacenter.

5. The computer-implemented method of claim 1, further comprising:
receiving, from the user device associated with the communication network, a second policy, wherein the second policy includes an intent to configure a second SSE provider to which the router can establish a respective secure tunnel.

6. The computer-implemented method of claim 1, wherein the information associated with the at least one datacenter includes at least a destination IP address and a geolocation associated with one or more datacenters of the SSE provider.

7. The computer-implemented method of claim 1, wherein when the router receives the action command, the router establishes the secure tunnel with the SSE provider using the action command.

8. A system comprising:
one or more processors; and
a memory storing instructions that, when executed by the one or more processors, configure the system to:
receive, from a user device associated with a communication network, a policy, wherein the policy includes an intent to configure a security service edge (SSE) provider;
transmit the policy to a router associated with the communication network;
receive, from the router, a request for a secure tunnel between the router and the SSE provider;
using one or more application programming interfaces (APIs), determine information associated with at least one datacenter via which services by the SSE provider are accessible;
generate tunnel configurations for the secure tunnel associated with the router, based on the information associated with the at least one datacenter;
generate an action command that includes instructions for configuring the secure tunnel between the router and the SSE provider using the tunnel configurations; and
transmit the action command to the router.

9. The system of claim 8, wherein the instructions further configure the system to:
store the information associated with the at least one datacenter in a database associated with the communication network; and
query the database for the information associated with the at least one datacenter in response to a subsequent request for an additional secure tunnel associated with the SSE provider.

10. The system of claim 8, wherein the tunnel configurations includes at least one of a tunnel destination Internet Protocol (IP) address and a secure key.

11. The system of claim 8, wherein the one or more APIs are used to request location information of the at least one datacenter associated with the SSE provider, the location information being included in the information associated with the at least one datacenter.

12. The system of claim 8, wherein the instructions further configure the system to:
receive, from the user device associated with the communication network, a second policy, wherein the second policy includes an intent to configure a second SSE provider to which the router can establish a respective secure tunnel.

13. The system of claim 8, wherein the information associated with the at least one datacenter includes at least a destination IP address and a geolocation associated with one or more datacenters of the SSE provider.

14. The system of claim 8, wherein when the router receives the action command, the router establishes the secure tunnel with the SSE provider using the action command.

15. A non-transitory computer-readable storage medium, the non-transitory computer-readable storage medium including instructions that when executed by a computer, cause the computer to:
receive, from a user device associated with a communication network, a policy, wherein the policy includes an intent to configure a security service edge (SSE) provider;
transmit the policy to a router associated with the communication network;
receive, from the router, a request for a secure tunnel between the router and the SSE provider;
using one or more application programming interfaces (APIs), determine information associated with at least one datacenter via which services by the SSE provider are accessible;
generate tunnel configurations for the secure tunnel associated with the router, based on the information associated with the at least one datacenter;
generate an action command that includes instructions for configuring the secure tunnel between the router and the SSE provider using the tunnel configurations; and
transmit the action command to the router.

16. The non-transitory computer-readable storage medium of claim 15, wherein the instructions further configure the computer to:
store the information associated with the at least one datacenter in a database associated with the communication network; and
query the database for the information associated with the at least one datacenter in response to a subsequent request for an additional secure tunnel associated with the SSE provider.

17. The non-transitory computer-readable storage medium of claim 15, wherein the tunnel configurations includes at least one of a tunnel destination Internet Protocol (IP) address and a secure key.

18. The non-transitory computer-readable storage medium of claim 15, wherein the one or more APIs are used to request location information of the at least one datacenter associated with the SSE provider, the location information being included in the information associated with the at least one datacenter.

19. The non-transitory computer-readable storage medium of claim 15, wherein the information associated with the at least one datacenter includes at least a destination IP address and a geolocation associated with one or more datacenters of the SSE provider.

20. The non-transitory computer-readable storage medium of claim 15, wherein when the router receives the action command, the router establishes the secure tunnel with the SSE provider using the action command.
